(19) United States
(12) Patent Application Publication
(10) Pub. No.: US 2014/0284394 A1
(43) Pub. Date: Sep. 25, 2014

(54) INJECTION ELEMENT

(71) Applicants: Philippe James, Vernon (FR); Carlos Cruz, Gaillon (FR)

(72) Inventors: Philippe James, Vernon (FR); Carlos Cruz, Gaillon (FR)

(73) Assignee: SNECMA, Paris (FR)

(21) Appl. No.: 14/131,123

(22) PCT Filed: Jun. 27, 2012
(86) PCT No.: PCT/FR2012/051473

§ 371 Date: May 22, 2014

(30) Foreign Application Priority Data
Jul. 7, 2011 (FR) 11 56143

(51) Int. Cl. F02M 55/04; F02M 43/04

(52) U.S. Cl. CPC F02M 55/04; F02M 43/04
USPC 239/5; 239/408

(57) ABSTRACT

An injection element for injecting two propellants into a combustion chamber, and usable for a rocket engine including at least one combustion chamber of type having an injector including one or more such injection elements. The injection element includes a first annular duct for injecting a first propellant and a second annular duct for injecting a second propellant, the second duct being coaxial with and externally adjacent to the first duct, and potentially a third annular duct that is coaxial with and externally adjacent to the second duct. The first duct surrounds a central body of the injection element, the central body including a cavity in communication with an outer surface of the central body and configured to damp at least one predetermined acoustic frequency.

The present invention relates to an injection element for injecting two propellants into a combustion chamber, and more particularly designed for a rocket engine with at least one combustion chamber, the chamber being of the type having an injector made up of one or more such injection elements. The invention relates more particularly to an improvement applied to such an injection element, in its downstream portion where the two propellants mix together, in order to reduce the acoustic noise in the combustion chamber.

Patent document FR 2 712 030 A1 describes a two-propellant injector in a rocket engine combustion chamber, the injector comprising a feed structure in which the two propellants feed a plurality of injection elements arranged mutually in parallel in an axisymmetric configuration on the surface of a circular structure referred to as an “injection plate” and forming part of the injector. Such an injection plate can thus be associated with quite a large number of injection elements, e.g. as many as a hundred or more, combining their individual flow rates in order to deliver the total flow rate to the engine.

In that injector of the prior art, each injection element comprises at least a first duct for injecting the first propellant, and a second duct for injecting the second propellant, the second duct being annular, coaxial, and externally adjacent to the first duct.

In the present context, the term “annular duct” is used to mean a duct that, in radial section, reveals an annular flow section, whereas the term “tubular duct” is used to mean a duct having a full flow section. In addition, the terms “upstream” and “downstream” are defined relative to the flow direction of the propellants.

Thus, since the propellants are injected into the combustion chamber via coaxial ducts of the injection elements of the FR 2 712 030 A1 injector, the turbulence generated in the boundary layers between the concentric and adjacent flows can serve to provide uniform mixing of the two propellants by shear between their flows.

Nevertheless, starting from that basic concept in which the first duct is tubular, difficulties are encountered in varying the geometrical parameters in order to increase the individual power of each injected element without degrading the quality of the injection and of the combustion.

In addition, in operation, such a combustion chamber may generate combustion noise that might even enter into strong acoustic coupling with resonant modes of vibration of the chamber. Such acoustic vibrations can thus enter into resonance, and reach amplitudes liable to give rise to irreversible damage to the combustion chamber and to the injector.

Attempts have previously been made to reduce the sound level in such combustion chambers with damper devices at the periphery of the injection plate. The damper devices that are most commonly used are deflectors, also known as “baffles”, and acoustic cavities. Nevertheless, such damper devices present considerable drawbacks of increasing the weight, the size, the complexity, and the manufacturing cost of the combustion chamber, and as well as requiring additional validation testing, they also need in particular to have thermomechanical strength properties in an environment that is particularly demanding.

An object of the present invention is thus to propose an injection element that enables those drawbacks to be remedied.

This object is achieved by the fact that the first duct is also annular, surrounding a central body of the injection element, said central body having at least one cavity in communication with an outer surface of the central body and configured to damp at least one predetermined acoustic frequency f.

By means of these provisions, it is possible to reduce the flow section of the first propellant flowing in the first duct by acting on the diameter of the central body. Consequently, even if the flow sections of all of the ducts are increased for the purpose of increasing the power of such an injection element, it is possible to ensure that the speed of the propellant flowing in the annular first duct does not decrease, other things remaining equal. The quality of the injection and of the combustion can thus be maintained in a manner that is independent of the dimensioning of the injection element. In addition, incorporating the acoustic damper cavity in the central body enables it to be incorporated within the injector without occupying any additional space, and places the damper means in the immediate proximity of the sources of noise.

In certain embodiments, said acoustic damper cavity is configured as a Helmholtz resonator, with a volume V in communication with an outer surface of the central body via an orifice with a section of area A and of length l₀. Such a Helmholtz resonator presents a resonant acoustic frequency given by the following equation:

$$f = \frac{c}{2 Π} \sqrt{\frac{A}{V {𝓁}_{0}}}$$

in which c represents the propagation speed of sound in the fluid contained in the cavity. A Helmholtz resonator tuned to predetermined excitation frequency f serves to dissipate at least some of the acoustic wave energy at that frequency.

In a particular embodiment of such an injector element, the orifice connecting the cavity to the outer surface of the central body is substantially coaxial with said first and second ducts. In this way, the orifice faces in the direction from which the major fraction of the combustion noise comes.

In an alternative embodiment, the cavity communicates directly with the first duct via the orifice which is pierced laterally in the outer surface of the central body. This makes it possible to damp acoustic waves propagating upstream via the first duct.

As an alternative to the Helmholtz resonator configuration, in other embodiments, said cavity is configured as an axial bore in the central body having a depth lₚ that is substantially equivalent to one-fourth of the wavelength λ corresponding to the predetermined acoustic frequency f. In the present context, an orientation is said to be “axial” when it is the orientation of the propellant flow. The cavity thus forms a quarterwave tube serving to attenuate acoustic waves of frequency f.

In order to further improve the mixing of the two propellants downstream, an injection element in certain embodiments also includes a third duct that is also suitable for injecting the first propellant, said third duct being annular and coaxial relative to the first and second ducts and being externally adjacent to the second duct. Thus, the flow of the second propellant is subjected to shear twice between inner and outer flows of the first propellant, and this can result in even more uniform mixing.

The invention also provides an injector having at least one injection element as described above, a combustion chamber including at least one injector, and a rocket engine including at least one combustion chamber. The term “combustion chamber” is used in the present context to mean not only a main single-element combustion chamber of a rocket engine, but, among other things, also one or more elements of a multi-element combustion chamber, a pre-chamber for a staged combustion engine, or a gas generator, e.g. for driving a turbopump for feeding propellants.

The invention also provides a method of damping a combustion noise in a combustion chamber, wherein a predetermined acoustic frequency f is damped in a cavity of a central body of an injection element for injecting a mixture of two propellants into the combustion chamber, said injection element comprising at least a first annular duct for injecting a first propellant that is externally adjacent to the central body, and at least a second annular duct for injecting a second propellant, which second duct is coaxial with and externally adjacent to the first duct. Particularly, but not necessarily, this injection element may additionally have a third duct, also suitable for injecting the first propellant, said third duct being annular and coaxial with the first and second ducts, being externally adjacent to the second duct.

The invention can be well understood and its advantages appear better on reading the following detailed description of three embodiments given as non-limiting examples. The description refers to the accompanying drawings, in which:

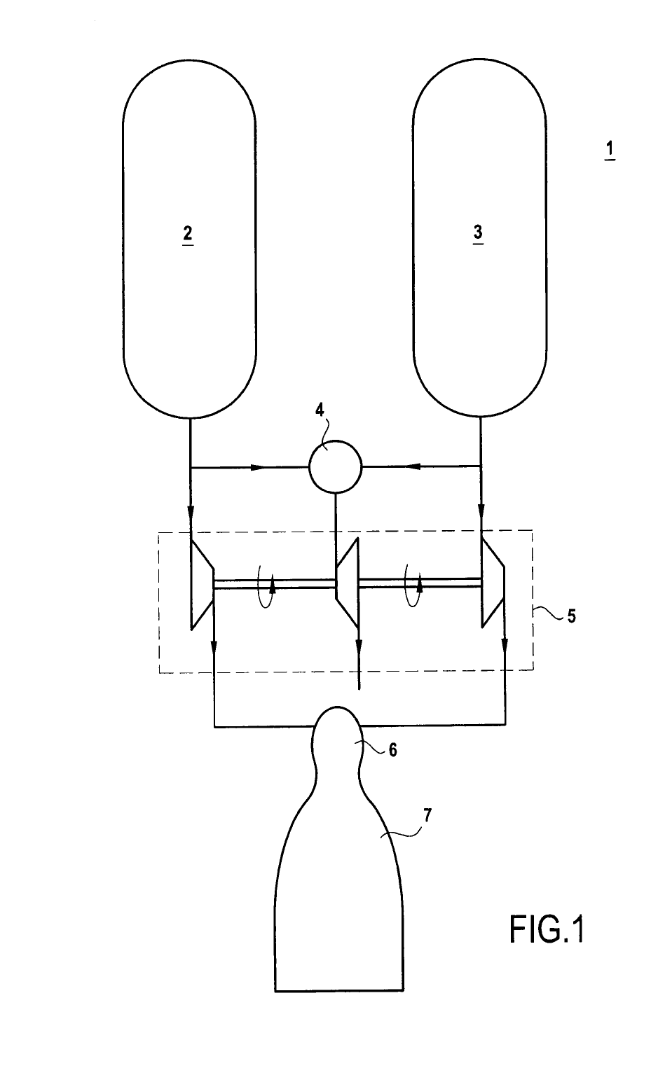

FIG. 1 is a diagrammatic view of a liquid propellant rocket engine:

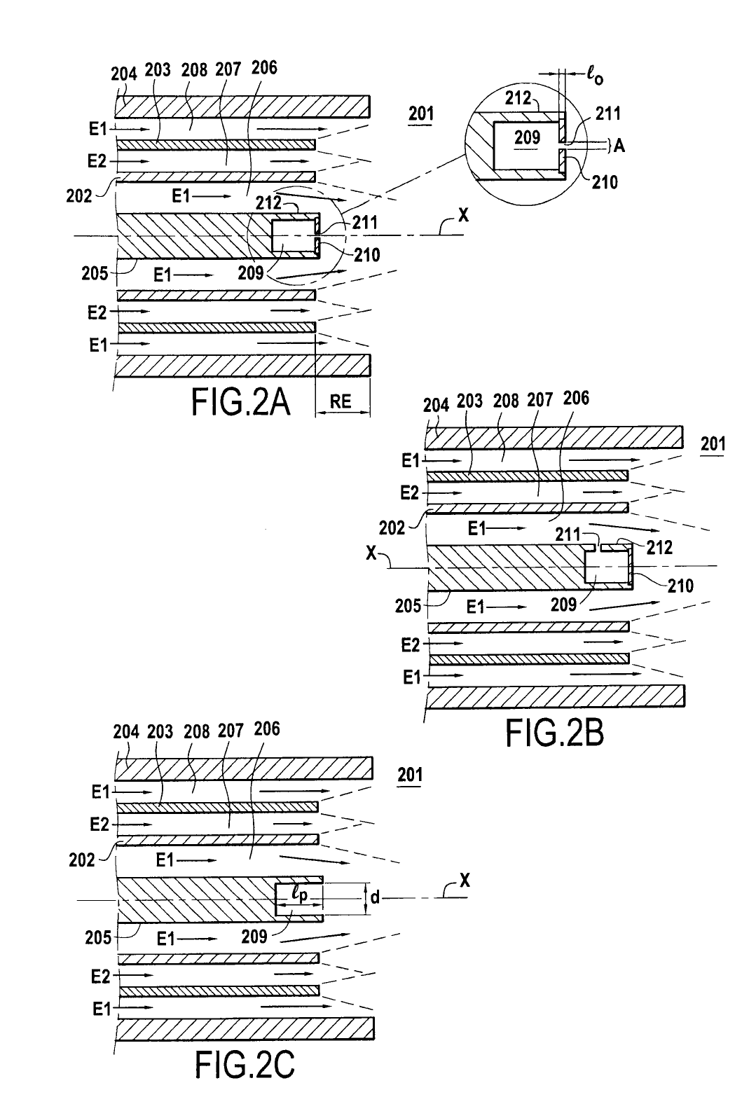

FIGS. 2A, 2B, and 2C are longitudinal sections of injection elements in first, second, and third embodiments; and

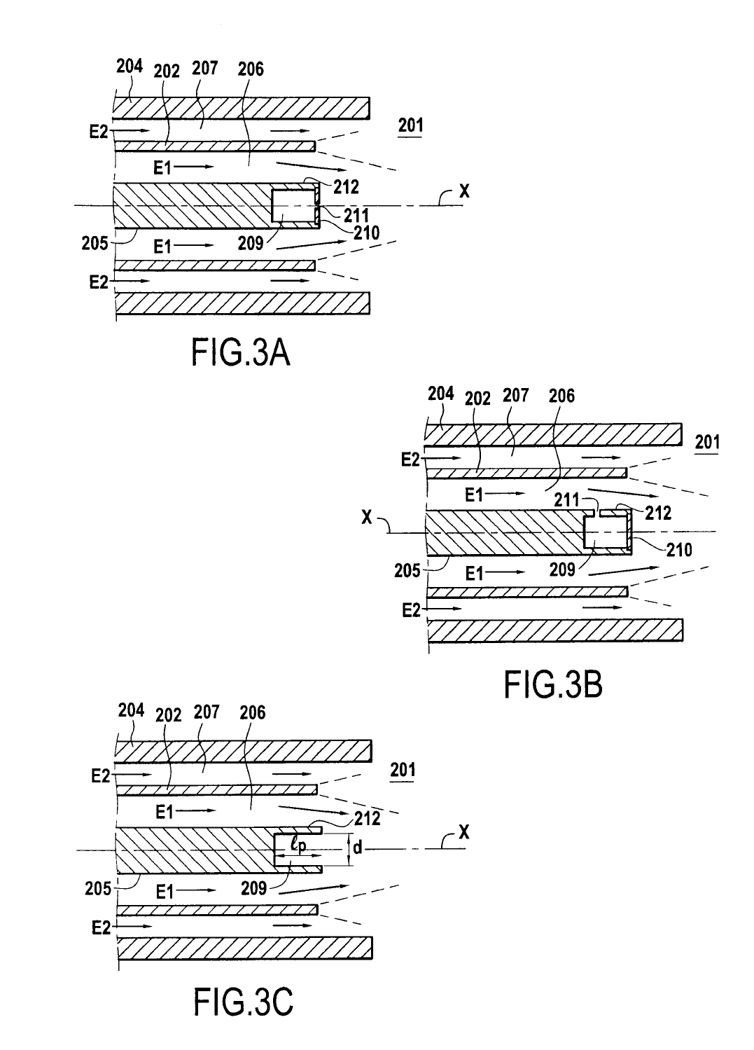

FIGS. 3A, 3B, and 3C are longitudinal sections of injection elements in fourth, fifth, and sixth embodiments.

A rocket engine 1 using liquid propellants, in particular cryogenic liquid propellants, is shown diagrammatically in FIG. 1. The rocket engine 1 has a tank 2 for a first propellant, a tank 3 for the second propellant, a gas generator 4 fed with the first and second propellants, a turbopump 5 driven by combustion gas coming from the gas generator 4, a main combustion chamber 6 fed with propellants by the turbopump 5, and a converging-diverging nozzle 7 for propulsive ejection of the combustion gas generated in the main combustion chamber 6.

In order to obtain combustion that is effective both in the gas generator 4 and in the main combustion chamber 6, these components have propellant injection elements enabling the propellants to be mixed and distributed uniformly. Typically, the injection elements are mounted on an injection plate fed with the injected propellants.

In FIG. 2A, there can be seen the terminal portion of an injection element 201 of tri coaxial structure for injecting and mixing two propellants E1, E2. The injection element 201 has an axis of symmetry X that is also the main flow axis of the propellants E1, E2. The way in which the various component parts of the injection elements are arranged relative to one another and held in their respective positions while being connected to the two feed circuits for feeding the propellants E1 and E2 is not shown.

In its terminal portion, the injection element 201 has three concentric tubular walls 202, 203, and 204 around a central body 205 so as to form first, second, and third ducts 206, 207, and 208 that are annular and coaxial. A setback RE is defined between the end of the outer envelope, i.e. the outermost tubular wall 204, and the intermediate walls 202, 203. The outer wall 204 may be part of the injection plate itself, and the intermediate walls 202, 203 may be incorporated in a single body, being joined together upstream.

The first and third ducts 206, 208 are configured to inject the first propellant E1, while the second duct 207, situated radially adjacent to the outside of the first duct 206 and to the inside the third duct 208, is configured to inject the second propellant E2. Since the first and second propellants E1 and E2 are injected at different speeds while the injection element 201 is in operation, shear on the inside and on the outside of the annular stream of the second propellant E2 in the setback RE gives rise to turbulence in the streams of the two propellants E1, E2, thereby ensuring that the two propellants E1, E2 mix uniformly. In addition, since the three ducts 206, 207, and 208 are annular, the injection element 201 can easily be dimensioned to match the required total propellant flow rate.

In this first embodiment, the central body 205 has a cavity 209 of volume V that is formed by a plate 210 perforated by an orifice 211 substantially in alignment on the central axis X of the injection element. The orifice 211 presents a section of area and a length l₀, and the cavity 209 is put into communication with an outer surface 212 of the central body 205 facing the combustion chamber 213. The cavity 209 with the orifice 211 thus forms a Helmholtz resonator having a resonant frequency f given by the following equation:

$$f = \frac{c}{2 Π} \sqrt{\frac{A}{V {𝓁}_{0}}}$$

This Helmholtz resonator makes it possible to dissipate at least some of the acoustic energy that the combustion emits at this frequency f. With an appropriately dimensioned cavity 209 and orifice 211, it is possible to damp combustion noise effectively at a predetermined frequency f, such as for example a frequency that can lead to resonance effects in the structure of the combustion chamber.

In a second embodiment, shown in FIG. 2B, the injection element 201 is likewise a tri coaxial type element with tubular walls 202, 203, and 204 forming first, second, and third annular and coaxial ducts 206, 207, and 208 around a central body 205. As for the first embodiment, a setback RE is defined between the end of the outer envelope, i.e. the outermost tubular wall 204, and the intermediate tubular walls 202 and 203. The first and third ducts 206 and 208 are likewise configured for injecting the first propellant E1, while the second duct 207 is situated radially adjacent to the outside of the first duct 206 and to the inside of the third duct 208, is configured for injecting the second propellant E2.

In contrast, in this second embodiment, the orifice 211 is not pierced in the plate 210 closing the cavity 209 of the central body 205, but is located laterally in the outer surface 212 of the central body 205 so as to put the cavity 209 into direct communication with the first duct 206, for the purpose of damping soundwaves propagating in the setback RE and in the first duct 206.

In a third embodiment shown in FIG. 2C, the injection element 201 is likewise an element of the tri coaxial type with tubular walls 202, 203, and 204 forming first, second, and third annular and coaxial ducts 206, 207, and 208 around a central body 205. As in the first and second embodiments, a setback RE is defined between the end of the outer envelope, i.e. the outermost wall 204, and the intermediate walls 202 and 203. The first and third ducts 206 and 208 are likewise configured for injecting the first propellant E1, while the second duct 207 that is situated radially adjacent to the outside of the first duct 206, and the inside of the third duct 208 is configured for injecting the second propellant E2.

In contrast, in this third embodiment, the cavity 208 is not closed by a plate, but is configured as an axial bore of diameter d in the central body 205 that is open towards the combustion chamber 214 and that is blind, presenting a depth lₚ that is substantially equal to one-fourth of the wavelength λ corresponding to the predetermined acoustic frequency f that is to be damped. Thus, the cavity 209 acts as a quarterwave tube for damping combustion noise during operation of the combustion chamber 214.

Although the first, second, and third embodiments relate to tri coaxial injection elements, the same concept can also be applied to simple coaxial injection elements. Thus, in a fourth embodiment as shown in FIG. 3A, the injection element 201 comprises, in its terminal portion, two concentric tubular walls 202 and 204 about a central body 205 so as to form first and second annular and coaxial ducts 206 and 207. A setback RE is defined between the end of the outer envelope, i.e. the outer tubular wall 204 and the intermediate wall 202. The wall 204 may be incorporated in the injection plate itself.

The first duct 206 is configured to inject the first propellant E1, while the second duct 207, situated radially adjacent the outside of the first duct 206, is configured to inject the second propellant E2. Since the first and second propellants E1 and E2 are injected at different speeds while the injection element 201 is in operation, shear between the annular streams of the two propellants E1 and E2 in the setback RE produces turbulence that ensures that the two propellants E1 and E2 are mixed uniformly. In addition, since the two ducts 206 and 207 are annular, it is easy to adapt the dimensioning of the injection element 201 to the required total propellant flow rate.

As in the first embodiment, the central body 205 has a cavity 209 of volume V that is closed by a plate 210 perforated by an orifice 211 substantially in alignment with the central axis X of the injection element. The orifice 211 presents a section of area A and a length and it puts the cavity 209 into communication with an outer surface 212 of the central body 205 facing the combustion chamber 213. The cavity 209 together with the orifice 211 thus form a Helmholtz resonator having a resonant frequency f.

In a fifth embodiment, shown in FIG. 3B, the injection element 201 likewise comprises in its terminal portion two tubular walls 202 and 204 that are concentric about a central body 205 so as to form first and second annular and coaxial ducts 206 and 207. A setback RE is also defined between the end of the outer envelope, i.e. the outer tubular wall 204 and the intermediate wall 202.

As in the above-described embodiments, the first duct 206 is configured for injecting the first propellant E1, while the second duct 207, which is situated radially adjacent to the outside of the first duct 206, is configured for injecting the second propellant E2.

As in the second embodiment, the cavity 209 is formed by an axial bore in the central body 205 and is put directly into communication with the first duct 206 via an orifice 211 formed laterally in the outer surface 212 of the central body 205 so as to put the cavity 209 in direct communication with the first duct 206, thereby forming a Helmholtz resonator serving to damp acoustic waves propagating in the setback RE and in the first duct 206.

Finally, in a sixth embodiment shown in FIG. 3C, the injection element 201 likewise comprises, in its terminal portion, two tubular walls 202 and 204 that are concentric around a central body 205 so as to form first and second annular and coaxial ducts 206 and 207 that are configured respectively for injecting first and second propellants E1 and E2. A setback RE is also defined between the end of the outer envelope, i.e. the outer tubular wall 204 and the intermediate wall 202.

As in the third embodiment, the cavity 209 is not closed by a plate, but is configured as an axial bore of diameter d in the central body 205, that is open towards the combustion chamber 214 and that is blind, presenting a depth lₚ that is substantially equal to one-fourth of the wavelength λ corresponding to the predetermined acoustic frequency f that is to be damped.

Although the present invention is described above with reference to specific embodiments, it is clear that various modifications and changes may be made to those examples without going beyond the general scope of the invention as defined by the claims. For example, although the central body in each of the embodiments shown has only one acoustic damper cavity, injectors constituting other embodiments could have a plurality of acoustic damper cavities, of the same type and/or of different types, which may be incorporated in the central body. Furthermore, individual characteristics of the various embodiments shown and/or described may be combined to produce additional embodiments. Consequently, the description and the drawings should be considered in a sense that is illustrative rather than restrictive.

1-10. (canceled)

11. An injection element for injecting a two-propellant mixture into a combustion chamber, comprising:
a first duct for injecting a first propellant; and
a second duct for injecting a second propellant, the second duct being annular, coaxial, and externally adjacent to the first duct;
and wherein the first duct is also annular and surrounds a central body of the injection element, the central body including at least one cavity in communication with an outer surface of the central body and configured to damp at least one predetermined acoustic frequency.

12. An injection element according to claim 11, wherein the cavity is configured as a Helmholtz resonator, with a volume V in communication with the outer surface of the central body via an orifice with a section of area A and of length l₀.

13. An injection element according to claim 12, wherein the orifice is substantially coaxial with the first and second ducts.

14. An injection element according to claim 12, wherein the cavity communicates directly with the first duct via the orifice which is pierced laterally in the outer surface.

15. An injection element according to claim 11, wherein the cavity is configured as an axial bore in the central body having a depth lₚ that is substantially equivalent to one-fourth of the wavelength λ corresponding to the predetermined acoustic frequency.

16. An injection element according to claim 11, further comprising a third duct configured to inject the first propellant, the third duct being annular and coaxial relative to the first and second ducts and being externally adjacent to the second duct.

17. An injector comprising:
at least one injection element for injecting a two-propellant mixture into a combustion chamber, the injection element comprising:
a first duct for injecting a first propellant; and
a second duct for injecting a second propellant, the second duct being annular, coaxial, and externally adjacent to the first duct; and
wherein the first duct is also annular, and surrounds a central body of the injection element, the central body including at least one cavity in communication with an outer surface of the central body and configured to damp at least one predetermined acoustic frequency.

18. A combustion chamber comprising:
at least one injector comprising at least one injection element for injecting a two-propellant mixture into a combustion chamber, the injection element comprising:
a first duct for injecting a first propellant; and
a second duct for injecting a second propellant, the second duct being annular, coaxial, and externally adjacent to the first duct; and
wherein the first duct is also annular, and surrounds a central body of the injection element, the central body including at least one cavity in communication with an outer surface of the central body and configured to damp at least one predetermined acoustic frequency.

19. A rocket engine comprising:
at least one combustion chamber comprising at least one injector comprising at least one injection element for injecting a two-propellant mixture into a combustion chamber, the injection element comprising:
a first duct for injecting a first propellant;
a second duct for injecting a second propellant, the second duct being annular, coaxial, and externally adjacent to the first duct; and
wherein the first duct is also annular, and surrounds a central body of the injection element, the central body including at least one cavity in communication with an outer surface of the central body and configured to damp at least one predetermined acoustic frequency.

20. A method of damping a combustion noise in a combustion chamber,
wherein a predetermined acoustic frequency is damped in a cavity of a central body of an injection element for injecting a mixture of two propellants into the combustion chamber,
the injection element comprising at least a first annular duct for injecting a first propellant that is externally adjacent to the central body, and at least a second annular duct for injecting a second propellant, which second duct is coaxial with and externally adjacent to the first duct.
